(19) United States
(12) Patent Application Publication
(10) Pub. No.: US 2009/0243540 A1
(43) Pub. Date: Oct. 1, 2009

(54) METHODS AND APPARATUS FOR BATTERY CHARGING MANAGEMENT

(75) Inventors: Kai-Wai Alexander Choi, Houston, TX (US); Sheung Wa Chan, Hong Kong (HK)

Correspondence Address: FULBRIGHT & JAWORSKI L.L.P., 600 CONGRESS AVE., SUITE 2400, AUSTIN, TX, 78701, US

(73) Assignee: Analog Express Inc., Hong Kong (HK)

(21) Appl. No.: 12/060,722

(22) Filed: Apr. 1, 2008

(51) Int. Cl. H02J 7/04; H02J 7/00

(52) U.S. Cl. 320/107; 320/150

(57) ABSTRACT

A method for managing the charging of a battery array 100, including the steps of: charging the battery array with a constant current at maximum rating 101; monitoring the status of a plurality of partitions among the battery array for overheating conditions 102; reducing the charging current to turn off charge balancing when overheat conditions are detected in any of the partitions 105; maintaining the charging current when overheat conditions are eliminated in all of the partitions 103; and repeating the steps of reducing and maintaining charging current until the charging current reaches the optimum rating where heat generated thereby can be tolerated.

### TECHNICAL FIELD

The present invention relates to methods and apparatus for charging a rechargeable battery array and further relates to methods and apparatus of reducing heat generated by charge balancer when charging a battery array.

### SUMMARY OF THE INVENTION

The rechargeable battery has been widely used as power source for low power consumption electronic devices such as digital cameras, laptop computers, and mobile phones. The electrical voltage and current delivered by a rechargeable battery is limited by the battery chemistry. Recent development in battery technology has overcome challenges such as high energy density and long cycle time, making heavy duty applications possible. Rechargeable batteries are now available for Battery Electric Vehicles (BEV), hybrid vehicles, and load leveling machines.

Rechargeable batteries can increase the output power by configuring voltaic cells in parallel, series, or in both to form an array structure. A parallel configuration of cells can supply a higher current whereas a series configuration offers the sum of the voltages of all the cells in series. To charge such a battery array, a charging current is usually applied across the positive and negative terminals of the battery array. Series cell configuration, however, suffers from a problem that, if one cell charges up faster than its neighbor, the full cell will limit the charging current flowing into the non-full cells. As a result, some of the cells in the battery take a long time to charge up and the charging process is inefficient. Most often, the user cannot wait until all cells are charged up or fully charged. The charging process has to be terminated with some of the cells not fully charged. As a result, the overall energy storing capacity of the battery cannot be fully utilized. As the battery cells degrade over use, charging capacity among cells becomes more deviated. The problem of unbalanced charging also gets more serious, and undesirably wastes a significant portion of the battery capacity. Apart from unbalanced charging, intrinsic faults in cells may also limit the charging current to neighbor cells.

Even if the user can tolerate a long charging time and the limited charging current may at long last charge up other cells, another problem is caused by the continuous application of charging current to those fully charged cells. As a result, the cell life may be substantially shortened.

A conventional method for solving the problem of unbalanced charging in serially connected battery cells is by battery cell matching during the manufacturing process. In this method, the charging capacity of each battery cell is measured after production. According to the measurement results, the batteries are categorized into various grades. Battery cells of the same grade are used in the same battery array to improve initial balance of charging capacity. Such steps result in extra manufacturing costs and time. Furthermore, the step of cell matching only improves unbalanced charging by trying to minimize the difference of charging capacity between cells, however difference in charging capacity still exists and the problem is not ultimately solved. In addition, significant capacity mismatch still happens in spite of initial cell matching when the battery cells start to degrade after prolonged use.

Aspects of the present invention have been developed with a view to substantially eliminate the drawbacks hereinbefore and to provide methods and apparatus for managing the charging of a battery array such that heat generation is substantially reduced.

A rechargeable battery array (or battery pack) with at least some of the battery cells connected serially can utilize charge balancers to achieve efficient charging despite capacity mismatch and/or failure in certain battery cell or cells among the battery array. For example, a charge balancer installed in parallel with each battery cell activates and provides a bypass path for charging current when that battery becomes substantially charged up. As a result, other non-fully charged batteries can still be charged by the bypass current such that the whole battery array can be fully charged in a much shorter time.

To speed up the charging process, a large charging current can be applied to the battery array. However, when the charge balancers are activated, such large charging current bypasses the battery cell and instead flows through the activated charge balancer. Hence, considerable amount of heat is generated which may undesirably burn up the circuit or cause circuit failures. As a result, large charging current cannot be used in known charging methods and thereby limiting the speed of the charging process.

Battery cells are stacked up as an array because large capacity, high voltage or large current is demanded by heavy duty applications. Such applications include Battery Electric Vehicles (BEV), hybrid vehicles, load leveling machines, submarines and satellites. For example in BEV, the current required to charge the battery array is in the order of 10 A. Battery cells are first connected in parallel as a battery row to supply the desired current, battery rows are further connected in series to constitute the complete battery array in order to provide the desired voltage. When one of the battery rows among the array gets fully charged and the charge balancer for that row starts to provide a bypass path for the charging current, a current of the order 10 A flows through the bypass path. The heat generated can be many decades larger than the situation in which battery cells are serially connected one by one, by virtue of the equation:

Dissipated power=(bypass current)×(voltage across bypass path)

The large amount of excessive heat generated may lead to high temperature conditions in the battery array if the heat is not efficiently dissipated to the environment. Such high temperature conditions have detrimental effects such as burn up of electronics circuits. In some battery, the electrolyte and separator may break down and result in gassing at the anode to release oxygen. The oxygen makes it more difficult to charge up the cell, and may ignite to cause explosion at sufficiently high temperature under the high pressure inside the cell. Such an effect is accelerated at higher operational temperatures. Such battery failure must be avoided because the effect is hazardous especially to running vehicles. Known methods to deal with the heat problem include utilization of complicated ventilation system, and large heat sinks. Instead of reducing heat generation by the heat sources, most of the existing solutions try to dissipate heat effectively by adopting expensive thermodynamic system for heat dissipation which however disadvantageously increase the manufacturing cost as well as the size of the battery system.

In addition, the electrical energy for charging battery is also wasted as heat energy resulting inefficient charging. This substantially increases the electric bill of the user especially for applications such as the BEV, in which the charging process is a day to day operation.

A need therefore exists for methods and apparatus to manage the charging of a battery array such that heat generation during charge balancing is substantially reduced.

It is the objective of the presently claimed invention to minimize heat generation during charge balancing and reduce the time that charge balancers are turned on, hence reduce the current through the charge balancers.

According to a first aspect of the claimed invention, there is disclosed a method for managing the charging of a battery array, including the steps of: charging the battery array with a constant current at maximum rating; monitoring the status of a plurality of partitions among the battery array for overheat conditions; reducing the charging current to turn off charge balancing when overheat conditions are detected in any of the partitions; maintaining the charging current when overheat conditions are eliminated in all of the partitions; and repeating the steps of reducing and maintaining charging current until the charging current reaches the optimum rating where heat generated thereby can be tolerated.

Advantageously, the step of charging the battery array with current at maximum rating is to charge with a large current that does not damage the battery cells.

The step of monitoring the status of a plurality of partitions among the battery array for overheat conditions may be actuated by communicating with a sensor in the each the partition.

The step of communicating with the sensor may be performed in broadcast-and subscribe-manner, wherein the sender (or publisher) broadcasts messages to a broadcast bus such as the Controller Area Network bus (CAN-bus). Receiver (or subscriber), on the other hand, subscribes messages based on various criteria. During communication, messages flow from the sender to the receivers according to the subscriptions.

The step of monitoring the status of a plurality of partitions is preferably to monitor the status of each charge balancer in the battery array. In one embodiment of the claimed invention, the step of monitoring the status of a plurality of partitions is to detect the turn-on status of each charge balancer. Overheat condition is met if any charge balancer turns on. In another embodiment of the claimed invention, the step of monitoring the status of a plurality of partitions is to measure the voltage across the terminals of each charge balancer. In a further embodiment of the claimed invention, the step of monitoring the status of a plurality of partitions is to measure the temperature of each charge balancer. While monitoring the turn-on status of charge balancer

Preferably, the step of reducing the charging current is to reduce the current each time by a predetermined step.

The method for managing the charging of a battery array may further include the step of constant current charging the battery array after the charging current reaches its optimum rating. Based on the described steps above, the charging current is reduced from time to time in order to keep all balancers off. However, a charging current that is too small will take a very long time to complete the remaining charging of the battery array. Therefore, an optimum rating can be selected to pose a lower limit to the charging current such that the current is still large enough to provide a reasonable charging time. In the meantime, the optimum current rating is not too large to cause overheating. The battery array is charged by constant current at the optimum rating until the termination condition for constant current charging is reached; and constant voltage charging the battery array until the termination condition for charging is reached.

In one embodiment of the claimed invention, the termination condition for constant current charging at optimum rating is determined by all charge balancers being turned on. In another embodiment of the claimed invention, the termination condition for constant current charging at optimum rating is determined by the length of period for the constant current charging. In yet another embodiment of the claimed invention, the termination condition for constant current charging is determined by the voltage across the terminals of the battery array. In a further embodiment of the claimed invention, the termination condition for constant current charging is determined by the length of period for the constant voltage charging.

The termination condition for charging is advantageously determined by the current through the terminals of the battery array.

The step of constant voltage charging is to charge with a voltage that does not turn on any of the charge balancers. Under constant voltage charging, charge leakage in the battery cell can be compensated by charging current made happen by the voltage drop due to charge leakage. Consequently, the cell is recharged and the cell voltage is brought back to the charging voltage. Similarly, unbalanced charge capacity of the battery cells among the battery array can be equalized by charging with a constant voltage.

According to a second aspect of the claimed invention, there is disclosed an apparatus for charging a battery array having multiple partitions of battery cells that includes switch mode power supply (SMPS) that charges the battery cells in constant current mode. The apparatus also has multiple charge balancers, each in parallel with one partition of battery cells and each provides a bypass path for charging current through the partition of battery cells when the partition of battery cells are substantially charged up. The apparatus further includes a battery management unit that is responsive to the turn-on status of the charge balancers and controls the SMPS to reduce the charging current, thereby turning off the charge balancers in all the partitions of battery cells.

The SMPS advantageously further includes a microcontroller (MCU) responsive to the control from the battery management unit and generates voltage references for the SMPS to output charging current of desired magnitudes.

Additionally, the SMPS may include: modulator for generating Pulse-Width-Modulation (PWM) signal to control a DC/DC power stage to output charging current of desired magnitudes; feedback and control circuit, responsive to the output of the SMPS and the voltage references from the MCU to control the modulator.

The SMPS is further operable to charge the battery cells in constant voltage mode based on the control from the battery management unit.

Other aspects of the invention are also disclosed.

### BRIEF DESCRIPTION OF THE DRAWINGS

Certain embodiments of the present invention will be described hereinafter in greater detail with reference to the drawings, in which:

FIG. 1 is a flow diagram illustrating the battery management system for charging a battery array according to an embodiment of the presently claimed invention.

FIG. 2 illustrates the current and voltage profile for charging a battery array according to an embodiment of the presently claimed invention.

FIG. 3 illustrates the equivalent circuit of a battery cell in terms of resistor and capacitor.

FIG. 4 is a block diagram illustrating the battery charging system according to an embodiment of the presently claimed invention.

FIG. 5 is a block diagram illustrating the battery management system for charging a battery array according to an embodiment of the presently claimed invention.

FIG. 6 is a flow diagram of the control algorithm according to an embodiment of the presently claimed invention.

### DETAILED DESCRIPTION

The present invention is described in detail herein in accordance with certain preferred embodiments thereof. To describe fully and clearly the details of the invention, certain descriptive names were given to the various components such as controller, digital signal processor, and frequency multiplier. It should be understood by those skilled in the art that these descriptive terms were given as a way of easily identifying the components in the description, and do not necessary limit the invention to the particular description.

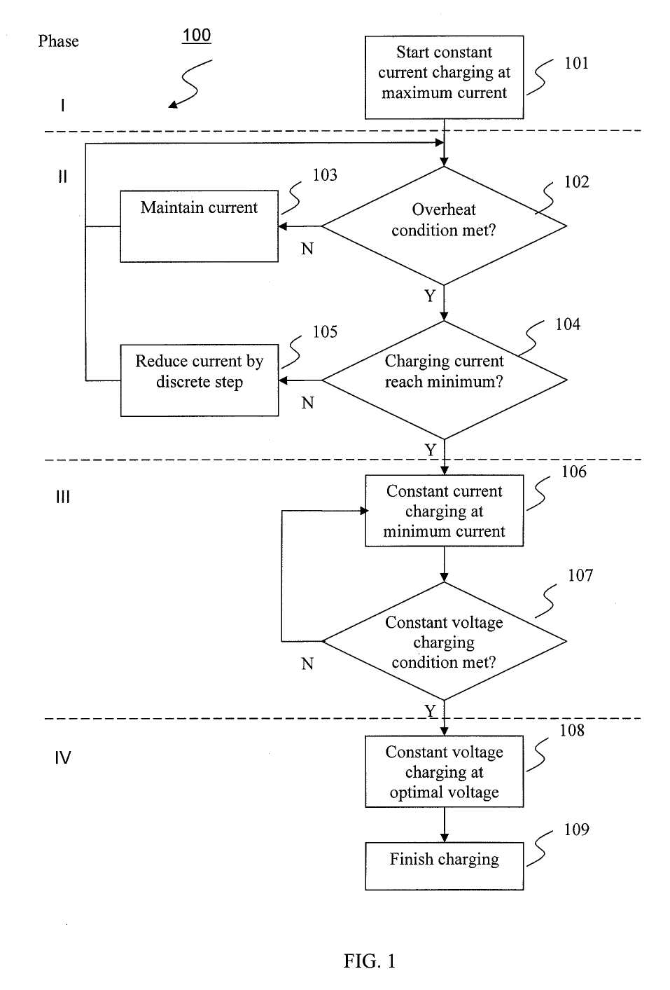

FIG. 1 is a flow diagram 100 illustrating the battery management system for charging a battery array according to an embodiment of the presently claimed invention. Processing commences in maximum current charging step 101 where an array of battery cells is charged by a constant current. The charging current at this stage is preferred to be as large as possible in order to speed up the charging process but in the meantime not damaging the battery cells. Such maximum value of charging current is usually determined by battery chemistry and varies for different designs and construction of battery cells. For example, the charging current on each single battery cell can be set as 2 C, where C is the nominal current capacity delivered by the battery cell.

In checking step 102, the condition for reducing charging current is checked. As the battery array continues to charge up, the voltage across of each battery cells may increase and reach the termination voltage, a value at which the corresponding charge balancers of the battery cells turn on to provide a bypass path for the charging current. The charging current is bypassed to flow through the charge balancer instead of the battery cell. The disadvantage of such change is the significant heat generated by the large bypass current when it flows through the charge balancer. Electrical energy is wasted in heat generation, while the circuit may get damaged. In order to reduce heat generation, the charging current is slightly reduced such that the voltage across each battery cell is also reduced lower than the termination voltage. As a result, the charge balancer is turned off.

Such a condition for reducing charging current is preferably related to heat generating status in the battery array. In an exemplary embodiment, the claimed invention aims at limiting the heat generated in the charge balancers which provides a bypass path for respective battery cell or respective group of battery cells. Therefore, the operating status of the charge balancer is monitored and whenever any of the charge balancers are turned on, the charging current is reduced. In another exemplary embodiment, the temperature of the battery array can be measured as the condition to reduce the charging current. Processing continues at step 104 if the condition for reducing charging current is met. Otherwise, processing continues at maintaining current step 103 where the charging current is maintained at a substantially constant value, and subsequently goes back to step 102 for monitoring the condition for reducing charging current.

In current monitoring step 104, it is checked whether the charging current has reached a minimum value. To limit the heat generated by the charge balancer, such minimum value is determined to be the current resulting in the maximum heat generation rating that can be tolerated. The minimum value is affected by the charge balancer design and heat dissipation arrangement. In an exemplary embodiment, the minimum charging current is set as 0.5 C. If the minimum charging current is reached, processing continues at minimum current charging step 106. Otherwise, processing continues at reducing current step 105.

In reducing current step 105, the charging current is reduced. This can be done by programming the switch mode power supply (SMPS) or adjusting the set point in the feedback circuit. The reduction of current is preferably performed by discrete steps though each step is not necessary to be constant. After the charging current is reduced, processing loops back to step 102 for monitoring the condition for reducing charging current. The looping continues until the current is reduced to a point to turn off the charge balancer.

In step 106, the battery array is being charged with constant current at the minimum value same as step 104, without further reducing the charging current.

In step 107, condition for constant voltage charging is examined. When the battery array is being charged by the minimum charging current for a certain period of time such that every battery cell is substantially full, the charger is switched to constant voltage charging mode. In one embodiment of the claimed invention, the condition for switching to constant voltage charging is determined upon all charge balancers having turned on. In another embodiment of the claimed invention, the switching to constant voltage charging is done after a fixed period of time from entering step 106, the time can be kept by a timer or a counting circuit. In a further embodiment of the claimed invention, the switching of constant voltage charging is triggered by the expiry of a fixed period of time after all the charge balancers have turned on. If the condition for switching to constant voltage charging is met, processing continues at step 108. Otherwise, processing loops back to step 106 for applying the minimum charging current to the battery array.

In step 108, the battery array is being charged with constant voltage. The charging voltage is preferably set to a point such that the voltage across each battery cell is just below the termination voltage in order to turn off all the charge balancers. For example, assuming there are M battery rows in parallel in a battery array, and each battery row contains N battery cells in series, the whole battery array is charged with a constant voltage at:

N×(termination voltage of each cell)

Accordingly, the heat generation caused by bypass current through the charge balancer stops while the charging progress is maintained. Under the constant voltage charging in this step, charge leakage in the battery cell can be compensated. When the cell voltage drops below the charging voltage due to charge leakage, the potential difference will cause charging current to flow into the cell, thereby charging the cell and raise the cell voltage back to the charging voltage. Similarly, unbalanced charge capacity of the battery cells among the battery array can be equalized by charging with a constant voltage.

In step 109, the charging process is finished. In one embodiment of the claimed invention, this can be performed under the command of the user, for example by switching off the charging power supply. In another embodiment of the claimed invention, the charging process is finished upon the expiry of a certain period of time after entering step 108.

The foregoing charging flow can be broken down into four consecutive phases:

I) maximum current charging phase—step 101;

II) heat managing phase—steps 102, 103, 104, 105;

III) minimum current charging phase—steps 106, 107; and

IV) constant voltage charging phase—steps 108, 109.

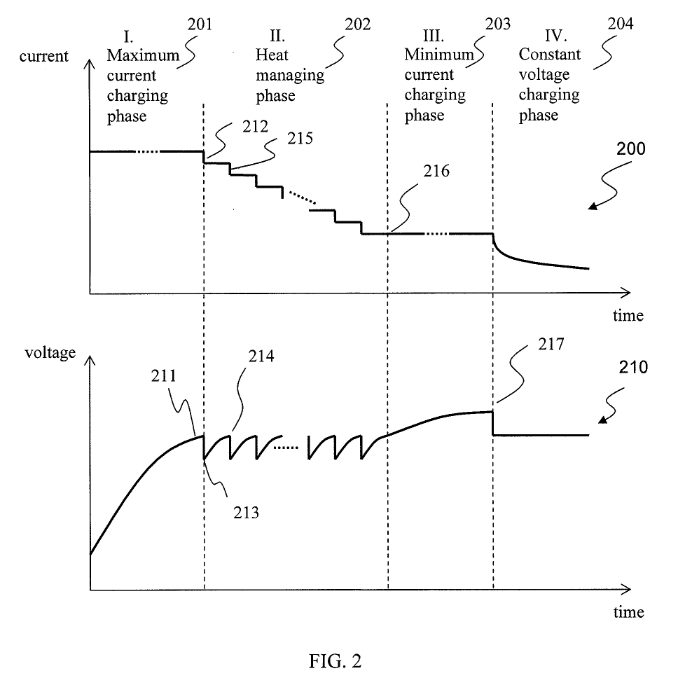

FIG. 2 illustrates the current profile 200 and voltage profile 210 for charging a battery array according to an embodiment of the presently claimed invention. According to current profile 200, charging process begins with the maximum current charging phase 201, where a constant current source such as a constant current mode power supply applies a large current to a battery array. The charging current at this stage is in one embodiment ideally set as the maximum rating or close to the maximum rating in order to speed up the charging process while not damaging the battery cells. The value of the maximum charging current rating is dependent on the battery chemistry and is usually available in the product specification of the battery cell. For example, the charging current applied to each single battery cell can be set as 2 C, where C is the nominal current capacity delivered by the battery cell. Assuming there are M battery rows being configured in parallel in a battery array, and each battery row further contains N battery cells in series, the whole battery array is charged with a constant current substantially equal to:

M×(maximum charging current for each cell)

Referring to the voltage profile 210, the voltage across the battery array rises gradually towards the termination voltage of the battery array as the constant current charging proceeds. At the charge balancer turn-on point 211, one or more of the battery cells may become substantially full earlier than the others. The voltage across this substantially full battery cell reaches the termination voltage where the charge balancer across that battery cell will turn on. Current starts to bypass that battery cell and flow through the charge balancer that has been turned on. Meanwhile, heat is generated as current flow through the bypass path in the charge balancer.

The charging process then migrates to the second phase, the heat managing charging phase 202. Upon detection of the on status of the charge balancer or the heat generation of the charge balancer, the charging current source reduces the current that is delivered to the battery array by a discrete step 212. Once the charging current is decreased, the voltage across each battery cell and hence the whole battery array will drop slightly. As the charging current is further decreased, the voltage across the substantially full battery cell drops to the charge balancer turn-off point 213 where the corresponding charge balancer start to turn off and heat generation is reduced in the bypass path. Upon detection of the off status of the charge balancer or the temperature drop of the charge balancer, the charging current is maintained in the existing value and continues to charge the battery array. The voltage across the battery array therefore rises again.

At charge balancer re-turn-on point 214, one or more of the charge balancers in the battery array is turned on when the corresponding battery cell reaches the termination voltage. Similar to situation at the charge balancer turn-on point 211, the charging current is reduced upon detection of the on status of the charge balancer or the heat generation of the charge balancer by a discrete step 215. The current source stops reducing the charging current and maintains it at a constant value when all the charge balancers are turned off again or the temperature drops below a predetermined value. Charging continues for the battery array, stepwise current drop recurs and the on-off cycle of the charge balancers repeats until minimum current point 216 where the charging current is reduced to the minimum value.

The value of such minimum charging current is defined as the current that causes the maximum tolerable heat generation. The minimum value may depend on the charge balancer design and heat dissipation arrangement. In an exemplary embodiment, the minimum charging current for each battery cell is set as 0.5 C. In a battery array consisting of M battery rows in parallel, and each battery row further contains N battery cells in series, the minimum charging current for the whole battery array is substantially equal to:

M×0.5 C

At point 216, the charge process proceeds to the third phase, the minimum current charging phase 203. The charging power source continues to charge the battery array with the minimum charging current irrespective of the heat generation in the bypass path.

As the voltage of the battery array rises to the point 217, the charging power source is switched to constant voltage charging mode. This happens when each cell in the battery array, after being charged by the minimum charging current for a certain period of time, becomes substantially full. The transition to constant voltage charging can be performed when all charge balancers have turned on, or when charging with the minimum charging current has been performed for a predetermined period of time. After the point 217, the battery array is charged at a constant voltage that keeps all charge balancers shut down. For illustrating purpose, a battery array, having M battery rows in parallel whereas each battery row having N battery cells in series, is charged with a constant voltage at:

N×(termination voltage of each cell)

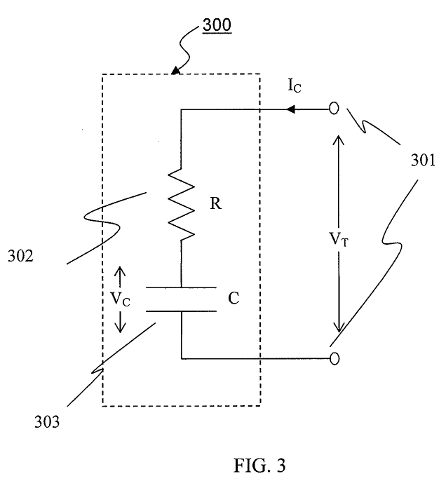

FIG. 3 illustrates the equivalent circuit 300 of a battery cell in terms of resistor and capacitor. A battery cell can be represented by an equivalent circuit consisting of one resistor 302 and one capacitor 303 connected in series configuration. V_{T}, the voltage across the battery cell terminals 301 is related to I_{C} the charging current flowing through the terminals 301 by the equation:

V_{T}=V_{C}+I_{C}R

where V_{C} is the voltage across the equivalent capacitor C.

In the heating managing phase illustrated in FIGS. 1 and 2, when V_{T} is high enough to turn on the corresponding charge balancer, the charging power source reduces the charging current I_{C}, and thereby decreasing the term I_{C} R. Accordingly, V_{T} drops linearly following the change in I_{C} and the charge balancer is turned off. As charging continues, it can be viewed as more electrical charges accumulating in the equivalent capacitor 303. Voltage across the equivalent capacitor, Vc therefore increases and hence boosts up the voltage across the battery cell terminals, V_{T}.

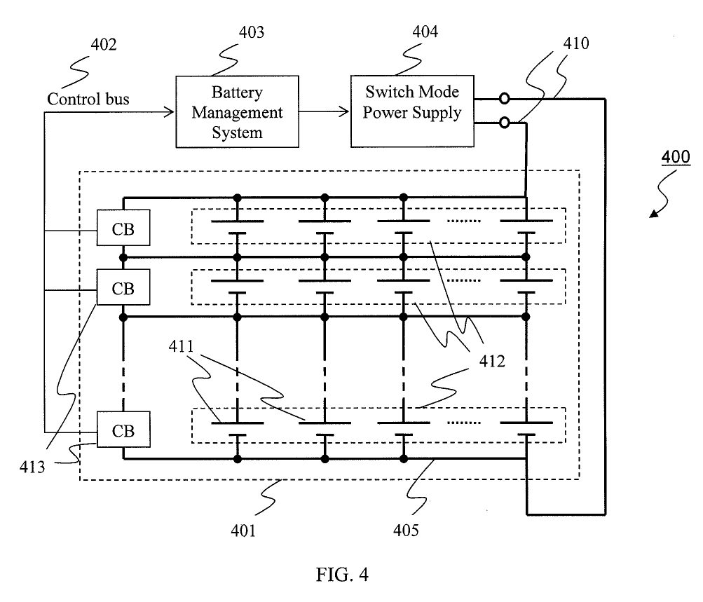

FIG. 4 is a block diagram illustrating the battery charging system 400 according to an embodiment of the presently claimed invention. Thick lines have been used to represent high current paths 405 for delivering charging current to the battery bank 401. The battery bank 401 is a battery array consisting of battery rows 412 connected in series. Each battery row 412 further includes battery cells 411 and at least some of the cells 411 are connected in parallel. A respective charge balancer 413 is arranged in parallel with each battery row 412 such that when the battery cells 411 in a battery row 412 gets substantially full, which is reflected by the terminal voltage of the battery row 412 reaching a termination voltage, that charge balancer 413 provides a bypass path for the charging current and no current further flows through that battery row 412 which is substantially full. The charge balancers 413 are in communication with the battery management system (or battery management unit) 403 through the control bus 402. Information passed through the control bus 402 may include the on/off status of the charge balancer 413, the temperature condition or over-temperature status of the charge balancer 413, and the terminal voltage of the corresponding battery row 412. Signal transport through the control bus 402 can be wired or wireless communication. In an exemplary embodiment, the control bus may adopt the Controller Area Network (CAN) Bus protocol.

Upon receipt of the information from charge balancers 413, the battery management system 403 makes decision based on control algorithm and controls the Switch Mode Power Supply (SMPS) 404 to adjust its output voltage and current for charging the battery bank 401. In particular, the battery management system 403 control the SMPS 404 to perform constant current charging at various current magnitudes in the maximum current charging phase, heat managing phase, and minimum current charging phase, and perform constant voltage charging at the constant voltage charging phase.

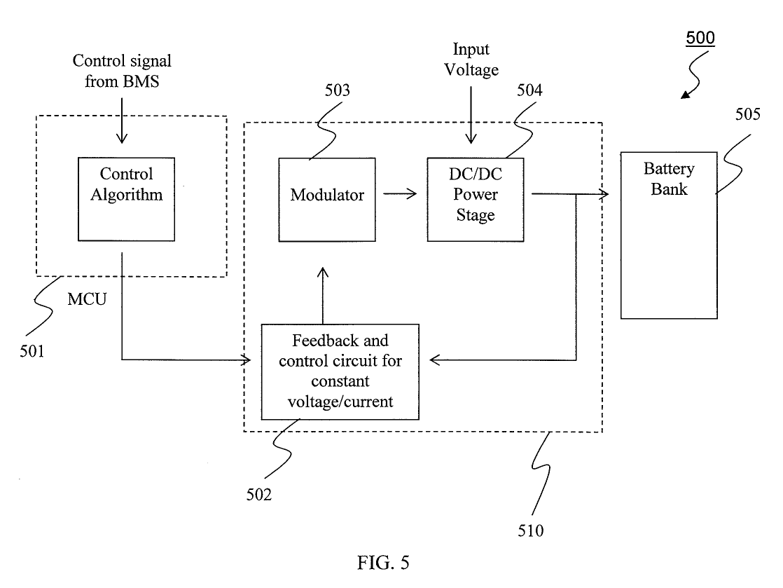

FIG. 5 is a block diagram illustrating the Switch Mode Power Supply (SMPS) 510 for a battery array charging system 500 according to an embodiment of the presently claimed invention. The SMPS 510 contains a microcontroller (MCU) 501 with a control algorithm stored in the program memory. The MCU 501 receives control signal from the battery management system (BMS) (not shown) and follows the control algorithm to control the feedback and control circuit 502. According to one embodiment of the claimed invention, the MCU 501 provides references voltage respectively to the constant current set point and constant voltage set point at the feedback and control circuit 502. For instance, the reference voltage that has a lower value dominates the control. If the reference voltage for constant current set point is set as the supply voltage VDD and reference voltage for constant voltage set point is set between VDD and ground (GND), the feedback and control circuit will drive the SMPS 510 in constant voltage mode.

In accordance with the control signal from the MCU 501, feedback and control circuit 502 controls the modulator 503 to generate the appropriate Pulse-Width-Modulation (PWM) signal to the DC/DC Power stage 504. The DC/DC Power stage 504 converts its input voltage to the desired voltage or current for charging the battery bank 505. The output of the DC/DC Power stage 504 is directly proportional to the duty cycle of the PWM signal generated by the modulator 503. In the meantime, the output of the DC/DC Power stage 504 is also fed back to the feedback and control circuit 502 to provide feedback control on the output.

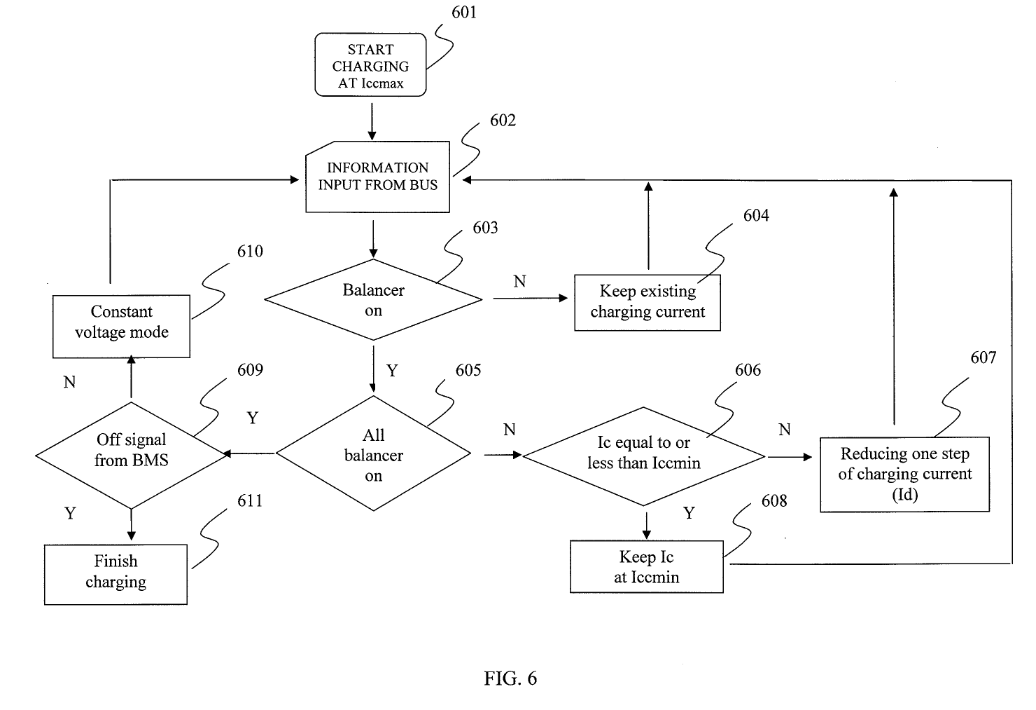

FIG. 6 is a flow diagram of the control algorithm of the battery management system (BMS) in FIG. 4 according to an embodiment of the presently claimed invention. Processing commences in maximum current charging step 601 where the SMPS starts charging at a constant current of maximum magnitude, I_{CCMAX}. In information acquiring step 602, the BMS collects information from the charge balancers distributed over the batter array through the control bus. Information gathered by the BMS may include the on/off status of the charge balancer, the temperature condition or over-temperature status of the charge balancer, and the terminal voltage of the corresponding battery row.

In balancer status detecting step 603, the system detects if any of the charge balancers has turned on. If no charge balancer is on, processing continues at step 604 where the SMPS keeps applying the existing charging current to the battery bank and thereafter loops back to information acquiring step 602. Otherwise, processing continues at all-balancer-on detecting step 605.

In all-balancer-on detecting step 605, the BMS further checks whether all the balancers are on. In case one or more balancers remain off, processing continues at step 606. Otherwise, processing continues at step 609.

In step 606, the BMS checks whether the existing charging current is equal to I_{CCMIN}, the minimum charging current. If no, processing proceeds to step 607 where the SMPS reduce the charging current by one predetermined step, thereafter processing loops back to step 602. Otherwise, processing continues at step 608 where the SMPS maintains the charging current I_{C} as I_{CCMIN} and then loops back to step 602.

In step 609, the BMS checks whether off signal is received. If no, processing continues at step 610 where the SMPS is switched to constant voltage mode and loops back to step 602. Otherwise, processing advances to step 611 and the charging process is finished.

### INDUSTRIAL APPLICABILITY

The arrangements described are applicable to the battery industries and particularly for battery charging system for heavy duty rechargeable batteries, including batteries for Battery Electric Vehicles (BEV), hybrid vehicles, submarines, load leveling machines and capacitor array in superconductor applications. The arrangements are especially suitable for battery arrays that utilize charge balancers to optimize the charging process.

The foregoing describes only some embodiment of the present invention, and modifications and/or changes can be made thereto without departing from the scope and spirit of the invention, the embodiments being illustrative and not restrictive.

We claim:

1. A method for managing the charging of a battery array, comprising:
charging a battery array with a constant current of a first value;
monitoring the status of a plurality of partitions among said battery array for overheating conditions;
reducing the charging current to turn off charge balancing when overheating conditions are detected in any of said partitions;
maintaining the charging current when overheating conditions are eliminated in all of said partitions; and
repeating the steps of reducing and maintaining charging current until the charging current reaches the a second value where heat generated thereby can be tolerated.

2. The method for managing the charging of a battery array of claim 1, wherein said step of charging said battery array with current of a first value is to charge with a current that attains substantially maximum charging speed while not damaging the battery cells.

3. The method for managing the charging of a battery array of claim 1, wherein said step of monitoring the status of a plurality of partitions among said battery array for overheat conditions further comprises the step of communicating with a sensor in each said partition.

4. The method for managing the charging of a battery array of claim 3, wherein said step of communicating with a sensor is performed through a broadcast bus protocol.

5. The method for managing the charging of a battery array of claim 1, wherein said step of monitoring the status of a plurality of partitions for overheating condition is to acquire the conditions of each charge balancer in said battery array.

6. The method for managing the charging of a battery array of claim 5, wherein said step of monitoring the status of a plurality of partitions for overheating condition is to detect whether each said charge balancer has turned on.

7. The method for managing the charging of a battery array of claim 5, wherein said step of monitoring the status of a plurality of partitions for overheating condition is to monitor the voltage across each said charge balancer.

8. The method for managing the charging of a battery array of claim 5, wherein said step of monitoring the status of a plurality of partitions for overheating condition is to monitor the temperature of each said charge balancer.

9. The method for managing the charging of a battery array of claim 1, wherein said step of reducing the charging current is to reduce the current each time by a predetermined value.

10. The method for managing the charging of a battery array of claim 1, further comprising:
constant current charging said battery array after the charging current reaches its optimum rating and charging at said optimum rating until the termination condition for constant current charging is reached; and
constant voltage charging said battery array until the termination condition for charging is reached.

11. The method for managing the charging of a battery array of claim 10, wherein said termination condition for constant current charging at optimum rating is determined by all charge balancers being turned on.

12. The method for managing the charging of a battery array of claim 10, wherein said termination condition for constant current charging at optimum rating is determined by the length of period for said constant current charging.

13. The method for managing the charging of a battery array of claim 10, wherein said termination condition for constant current charging is determined by the voltage across the terminals of said battery array.

14. The method for managing the charging of a battery array of claim 10, wherein said termination condition for constant current charging is determined by the length of period for said constant voltage charging.

15. The method for managing the charging of a battery array of claim 10, wherein said termination condition for charging is determined by the current through the terminals of said battery array.

16. The method for managing the charging of a battery array of claim 10, wherein said step of constant voltage charging does not turn on any of the charge balancers.

17. An apparatus for charging a battery array having multiple partitions of battery cells, comprising:
a switch mode power supply (SMPS), configured to charge said battery cells in constant current mode;
a plurality of charge balancers, each in parallel with one partition of battery cells and each provides a bypass path for charging current through said partition of battery cells when said partition of battery cells are substantially charged up; and
battery management unit, configured to control said SMPS to reduce the charging current in accordance with the turn-on status of said charge balancers, thereby turning off said charge balancers in all said partitions of battery cells.

18. The apparatus for charging a battery array having multiple partitions of battery cells according to claim 17, wherein said SMPS further comprises a microcontroller (MCU) configured to generate voltage references for said SMPS to output charging current of predetermined values in accordance with the control signal given by said battery management unit.

19. The apparatus for charging a battery array having multiple partitions of battery cells according to claim 18, wherein said SMPS further comprises:
a modulator configured to generate Pulse-Width-Modulation (PWM) signal to control a DC/DC power stage to output charging current of predetermined values;
a feedback and control circuit, configured to control said modulator based on the output of said SMPS and said voltage references from said MCU.

20. The apparatus for charging a battery array having multiple partitions of battery cells according to claim 19, wherein said SMPS is configured to charge said battery cells in constant voltage mode in accordance with the control signal given by said battery management unit.
